(19) United States
(12) Patent Application Publication
(10) Pub. No.: US 2025/0044022 A1
(43) Pub. Date: Feb. 6, 2025

(54) CO2 Separation Systems and Methods

(71) Applicant: CARBONQUEST, INC., Spokane Valley, WA (US)

(72) Inventors: William A. Fuglevand, Spokane Valley, WA (US); Shane Johnson, Rosalia, WA (US); Donald Francis Gongaware, Blaine, WA (US)

(73) Assignee: CARBONQUEST, INC., Spokane Valley, WA (US)

(21) Appl. No.: 18/927,140

(22) Filed: Oct. 25, 2024

Related U.S. Application Data
(63) Continuation-in-part of application No. PCT/US2023/020278, filed on Apr. 27, 2023.
(60) Provisional application No. 63/335,821, filed on Apr. 28, 2022.

(51) Int. Cl. F25J 1/00; F25J 3/06

(52) U.S. Cl. CPC F25J 1/0027; F25J 3/066; F25J 3/067; F25J 2210/70; F25J 2240/70; F25J 2260/80; F25J 2290/60

(57) ABSTRACT

Systems for separating CO₂ from a flue gas source are provided. The systems can include a liquefaction component operatively coupled to the separation component and comprising a recuperative heat exchanger configured to receive the separated CO₂ from the separation component and reduce the temperature of the separated CO₂ by exchanging the heat of the separated CO₂ with CO₂ vapor generated by the liquefaction component and/or a storage component operatively coupled to the liquefaction component and configured to receive liquid CO₂ from the liquefaction component. Methods for separating CO₂ from a flue gas source are provided. The methods can include liquefying the CO₂ stream to form both CO₂ liquid and CO₂ vapor; and using at least a portion of the CO₂ vapor to form the CO₂ liquid during the liquefying.

### CROSS REFERENCE TO RELATED APPLICATION

This application is a Continuation-in-Part of PCT Patent Application Serial No. PCT/US2023/020279 filed Apr. 27, 2023, entitled “CO₂ Separation Systems and Methods”, which claims priority to and the benefit of U.S. Provisional Patent Application Ser. No. 63/335,821 filed Apr. 28, 2022, entitled “CO₂ Separation Systems and Methods”, the entirety of each of which is incorporated by reference herein.

### TECHNICAL FIELD

The field of the invention relates to CO₂ separation systems and methods. In particular embodiments, the systems and/or methods can separate CO₂ and provide heat and/or power. In particular implementations, the heat and power can be provided to buildings. Also, combustion products as just one source of flue gas can be processed to separate CO₂ from the combustion products. Additionally, CO₂ can be separated from air. Further, power can be generated in the form of electricity while separating CO₂ from combustions products and/or air.

### BACKGROUND

Carbon dioxide generation in buildings, particularly in large metropolitan areas, is a significant contributor to carbon dioxide generation overall. Carbon dioxide is currently listed as a global warming compound whose reduction is sought worldwide. The generation of carbon dioxide is a necessary part of respiration, which is a necessary part of life, but it is important to limit the free distribution of carbon dioxide in an effort to address climate change. The present disclosure provides systems and methods for separating CO₂ from flue gas. The systems and methods can include transporting the separated CO₂ for sequestration and/or processing that limit the free distribution of CO₂. The present disclosure also provides power systems as well as power systems and methods for building emission processing and sequestration systems that can address carbon dioxide generation from combustion of fossil fuels and proliferation thereof in metropolitan areas. Additionally, the CO₂ separation systems and methods of the present disclosure can separate CO₂ from combustion products and/or air, and, in some embodiments, generated power in the form of electricity.

### SUMMARY

Systems for separating CO₂ from a flue gas source are provided. The systems can include: a flue gas source; the flue gas source comprising at least CO₂ and N₂; a separation component operatively coupled to the flue gas source and configured to separate CO₂ from N₂ and form separated CO₂; a liquefaction component operatively coupled to the separation component and comprising a recuperative heat exchanger configured to receive the separated CO₂ from the separation component and reduce the temperature of the separated CO₂ by exchanging the heat of the separated CO₂ with CO₂ vapor generated by the liquefaction component and/or a storage component operatively coupled to the liquefaction component and configured to receive liquid CO₂ from the liquefaction component; and the storage component comprising a CO₂ storage vessel and/or CO₂ transport vehicle; wherein one or both of the liquefaction component and/or the storage component are operatively coupled with the recuperative heat exchanger to provide at least a portion of the CO₂ vapor generated during liquefaction and/or storage to the recuperative heat exchanger for cooling the separated CO₂.

Methods for separating CO₂ from a flue gas source are provided. The methods can include: receiving a flue gas source stream comprising CO₂ and N₂; separating the CO₂ from the N₂ to form a primarily CO₂ stream; liquefying the CO₂ stream to form both CO₂ liquid and CO₂ vapor; and using at least a portion of the CO₂ vapor to form the CO₂ liquid during the liquefying.

### BRIEF DESCRIPTION OF DRAWINGS

Embodiments of the disclosure are described below with reference to the following accompanying drawings.

FIG. 1 is a CO₂ separation system and/or method according to an embodiment of the disclosure.

FIG. 2 is a depiction of flue gas sources that can provide flue gas for separation using the CO₂ separations systems and/or methods according to embodiments of the disclosure

FIG. 3A is an example combustion boiler equipped with a free oxygen sensor according to an embodiment of the disclosure.

FIG. 3B is a configuration of example combustion boilers operably coupled to a plenum according to an embodiment of the disclosure.

FIG. 3C is an example combustion boiler equipped with a free oxygen sensor according to an embodiment of the disclosure.

FIG. 4A is a portion of a CO₂ separation system and/or method according to an embodiment of the disclosure.

FIG. 4B is a portion of a CO₂ separation system and/or method according to another embodiment of the disclosure.

FIG. 4C is a portion of a CO₂ separation system and/or method according to another embodiment of the disclosure.

FIG. 5A is an example configuration of a component of a CO₂ separation system and/or method according to an embodiment of the disclosure.

FIG. 5B is another example configuration of a CO₂ separation system and/or method according to an embodiment of the disclosure.

FIG. 6 is a portion of a CO₂ separation system and/or method according to an embodiment of the disclosure.

FIG. 7A is a portion of a CO₂ separation system and/or method according to an embodiment of the disclosure.

FIG. 7B is the portion depicted in FIG. 7A in accordance with another implementation.

FIG. 8 is an example configuration of a component of a CO₂ separation system and/or method according to an embodiment of the disclosure.

FIG. 9A is an example of a CO₂ separation system according to an embodiment of the disclosure.

FIG. 9B is an example CO₂ separation system component and/or method according to an embodiment of the disclosure configured to operate as a carbonate pump.

FIG. 9C is an example CO₂ separation system component and/or method according to an embodiment of the disclosure configured to receive CO₂ and N₂ from a flue gas source and operate as a carbonate fuel cell.

FIG. 9D is an example CO₂ separation system and/or method according to an embodiment of the disclosure configured to receive CO₂ and N₂ from an air source and operate as a carbonate fuel cell.

FIG. 10A is a portion of a CO₂ separation system and/or method according to an embodiment of the disclosure.

FIG. 10B is another portion of a CO₂ separation system and/or method according to another embodiment of the disclosure.

FIG. 11 is a portion of a CO₂ separation system and/or method according to another embodiment of the disclosure.

FIG. 12 is a portion of CO₂ separation system and/or method according to an embodiment of the disclosure.

FIG. 13A is a portion of a CO₂ separation system and/or method according to an embodiment of the disclosure.

FIG. 13B is another portion of the CO₂ separation system and/or method of FIG. 13A according to an embodiment of the disclosure.

### DESCRIPTION

This disclosure is submitted in furtherance of the constitutional purposes of the U.S. Patent Laws “to promote the progress of science and useful arts” (Article 1, Section 8).

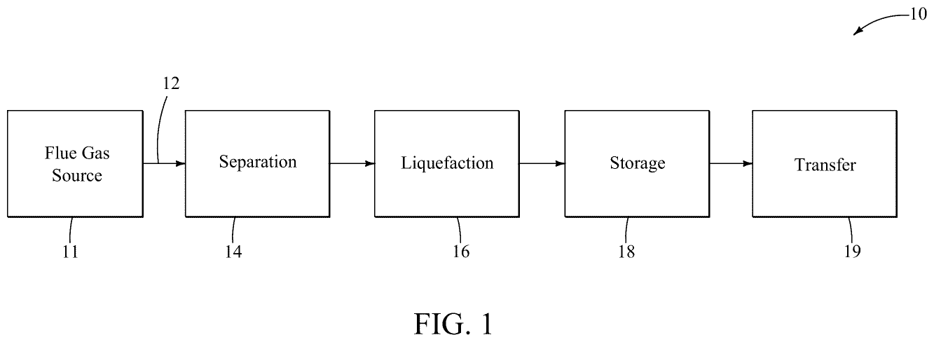

The present disclosure will be described with reference to FIGS. 1-13B. The systems and methods of the present disclosure can be operated unattended and/or continuously within a building for up to ten years with only minor periodic maintenance. In accordance with other embodiments, the CO₂ separation system and/or methods of the present disclosure can be operated outside a building and configured to receive flue gas from one or more flue gas sources. Referring first to FIG. 1, a system 10 is provided that includes a source of flue gas 11, such as a boiler, that combusts air and fuel to produce flue gas. Other sources of flue gas can include, but are not limited to, a combined heat and power generator, and/or a sorbent chiller (Absorbent or Adsorbent). Flue gas 12 can include typical combustion products from heating and/or cooling systems of a building. These buildings can be considered buildings that are commercial, residential, industrial, and/or mixed use. Building systems can provide flue gas to a series of portions of system and/or methods 14, 16, 18, and/or 19, for example, and/or as well as a cooling tower for the separation and/or capture of CO₂ from flue gas.

System 10 can rely on combustion of fuels such as fossil fuels and/or synthetic fuels which can include oxy fuels (combustion with enriched air). These fossil fuels can include oil, and/or natural gas. Upon combustion of fuel, CO₂ as part of flue gas can be produced. In the case of natural gas combustion, system 10 can generate at least about 10% CO₂ and about 18% water. Systems and/or methods of the present disclosure can include a portion 14 for separation, a portion 16 for liquefaction, a portion 18 for storage, and a portion 19 for transfer of CO₂.

In accordance with example implementations, at least about 600 standard cubic feet per minute of building flue gas can be diverted to the flue gas process stream where CO₂ is separated and purified in component 14 of system 10. This separation/purification component can be an adsorption purification system, operated under conditions of Pressure Swing (PSA), Vacuum Pressure Swing Adsorption (VPSA); Temperature Swing (TSA), or Electrical Swing (ESA), or any combination thereof. In accordance with example implementations, it can be a Pressure Swing Adsorption system that is a multicomponent adsorption system that includes multiple vessels containing layered solid phase adsorbent materials (e.g., structured materials) coupled and/or configured to work in concert to provide greater than 85% CO₂ recovery. These multicomponent adsorption systems can remove carbon dioxide from an essentially “dry” flue gas stream to a purity of greater than 95% in most cases, and in other cases, at least 99%. This purified carbon dioxide gas can then be liquified with successive cooling and compression steps to effect phase change to form liquid carbon dioxide in liquefaction component 16, and then providing that liquified carbon dioxide to a storage component 18 for scheduled removal as desirable. In accordance with example implementations, this liquified carbon dioxide can be transferred away in transfer component 19, and the transfer can be provided to another source such as a storage facility which can distribute the carbon dioxide for use in applications such as concrete curing, waste water treatment, other carbon dioxide sequestration methods, recycled for fire suppression systems, industrial specialty gas, consumed in production of hybrid fuels and organic intermediate chemicals, or for food and beverage quality standard applications such as beverage carbonation, as a few examples.

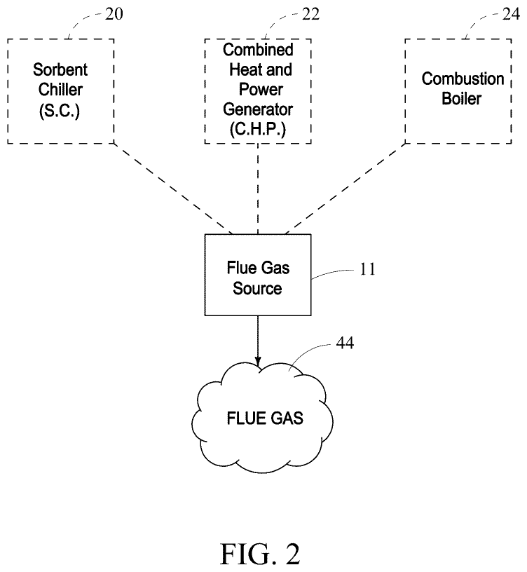

Referring next to FIG. 2, example flue gas sources are provided. One or more of these flue gas sources can be used to provide flue gas for CO₂ separation. For example, sorbent chiller (S.C.) 20 can include industrial sorbent chillers that are directly fired or run using steam. As another example, a combined heat and power (C.H.P.) generator 22 can be a source of flue gas. Additionally, a combustion boiler 24 may be a source of flue gas.

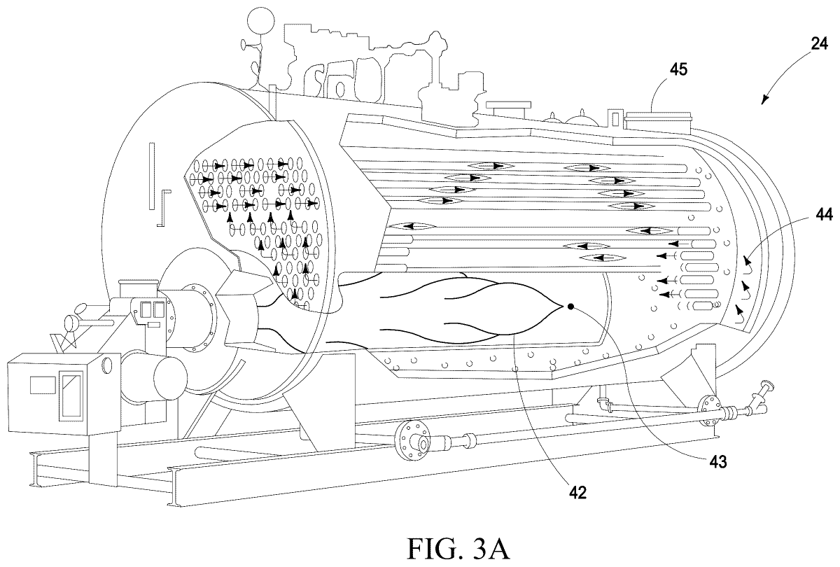

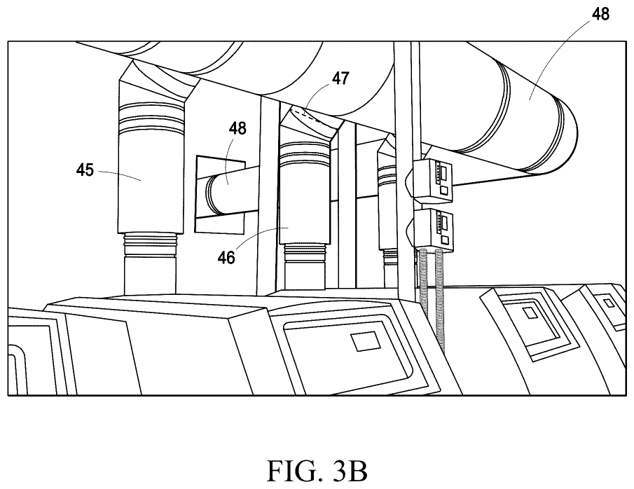

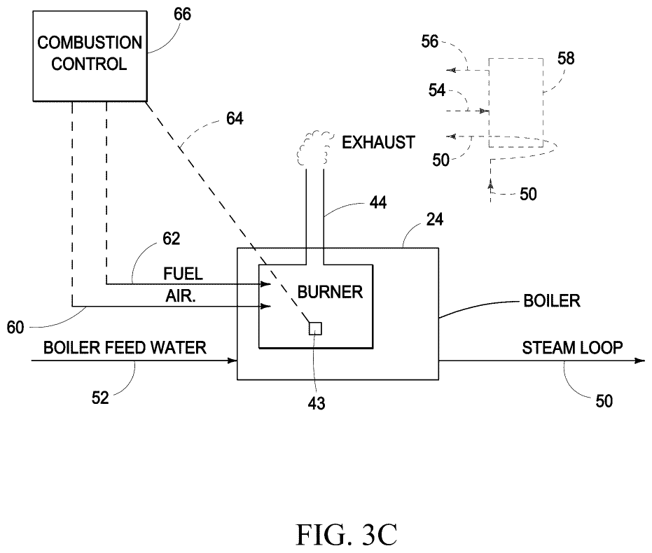

Referring next to FIGS. 3A-3C, example boiler configurations are shown as part of the systems and/or methods of the present disclosure. Referring first to FIG. 3A, a boiler 40 is shown generating combustion 42 in the presence of a free oxygen sensor 43. Combustion 42 generates flue gas 44 which is provided to a boiler exhaust 45. Referring to FIG. 3B, boiler exhaust is operatively coupled with a plenum 48. In this depicted configuration, multiple boilers are shown, each with an exhaust conduit 45 and 46, for example, each exhaust operatively coupled to plenum 48.

Referring next to FIG. 3C, a boiler configured with the systems and/or methods of the present disclosure is depicted. Accordingly, air 60 and fuel 62 can be provided to the combustion burner, the mix of which and accordingly the burn of which is controlled by combustion controller 66 which is operably connected with free oxygen sensor 43. Accordingly, boiler feed water 52 is received by the combustion boiler and heated to hot water or steam 50 which is used to heat the building and/or building systems such as water heater 58. Water heater system 58 can be configured to receive potable water for heating and/or industrial process water for heating.

In accordance with example implementations, control 66 can utilize sensor 43 to monitor the amount of free oxygen in the combustion burner and maintain the amount of free oxygen to about 3%. About 3% free oxygen can include free oxygen from 3 to 7%. In accordance with example implementations, combustion can generate flue gas 44. The composition of (wet) flue gas 44 can be controlled to include at least about 8% carbon dioxide. About 10% carbon dioxide can include carbon dioxide from 9 to 11% of the flue gas (dry basis) from combustion of natural gas. System 10 can be utilized to combust fuels other than natural gas which may dictate other optimal CO₂ flue gas concentrations. Accordingly, system 10 can be configured to utilize multiple fuels.

The systems and/or methods of the disclosure can include separating the carbon dioxide from the flue gas, liquefying the carbon dioxide after separating the carbon dioxide from the flue gas, liquefying the separated carbon dioxide after separating the carbon dioxide from the flue gas, storing the carbon dioxide after liquefying the carbon dioxide, and/or transporting the carbon dioxide after storing the carbon dioxide.

Referring to both FIGS. 3B and 3C, systems and/or methods for operating the combustion boiler within the building are provided that can include combusting air and fuel within the burner to produce flue gas 44 having an oxygen concentration; and restricting air from the flue gas by substantially eliminating tramp air within the conduit operably aligned to convey flue gas from the burner. In accordance with example implementations, in the case of multiple boilers as shown in FIG. 3B, exhausts 45 and 46 can be operatively aligned with plenum 48. Exhausts not in use, such as 46, can be a source of tramp air to the plenum. In accordance with example implementations, the systems and/or methods of the present disclosure can include providing fluid communication between the operating burner of one boiler and the plenum while restricting fluid communication between the plenum and an idle burner of the other operating boiler. In at least one configuration, a door or divider 47 can be provided and operable to eliminate tramp air from the exhaust of the idle burner.

In accordance with at least one aspect of the present disclosure, real time control of the combustion source, or boiler, can achieve higher efficiency to reduce consumption of natural gas or fuel, for example, while increasing the concentration of carbon dioxide in the flue gas. This may be considered counter intuitive to increase the concentration of carbon dioxide in the flue gas when the systems and/or methods of the present disclosure are being utilized to reduce carbon emissions from a building. However, increasing carbon dioxide concentration can provide the benefit of decreasing fuel consumption by reducing heat loss through the exhaust. Adjusting combustion to control free oxygen to 3% can give a higher efficiency burn. In accordance with example implementations, through combustion control, it is desirable to approach the 12% concentration value of CO₂, when burning natural gas, and achieve at least about 10% carbon dioxide concentration in the flue gas (dry basis). This is at least one feature of the disclosed building emission processing systems and/or methods and can be utilized as one of the initial steps in carbon capture.

Within the building, boiler operation can be dictated by responding to the need for hot water or steam by controlling the combustion burner to various predetermined firing rates; 1) an off condition, 2) a low fire rate, and/or 3) a high fire rate. These rates may have been established on older boilers through calibrated mechanical linkages, for example. Recognizing that cyclic boiler operation will vary widely from hour to hour, day to day, and season to season, it is desired to establish automatic control of the flame rate continuously across the entire boiler load range, while also controlling free oxygen as discussed above. The systems and/or methods of the present disclosure can be configured to reduce on-off cycles by extending boiler run time at a reduced flame rate, increasing the life on the boilers, and providing a more continuous flow of flue gas to the separation, liquefaction, storage and/or transport systems and/or methods of present disclosure.

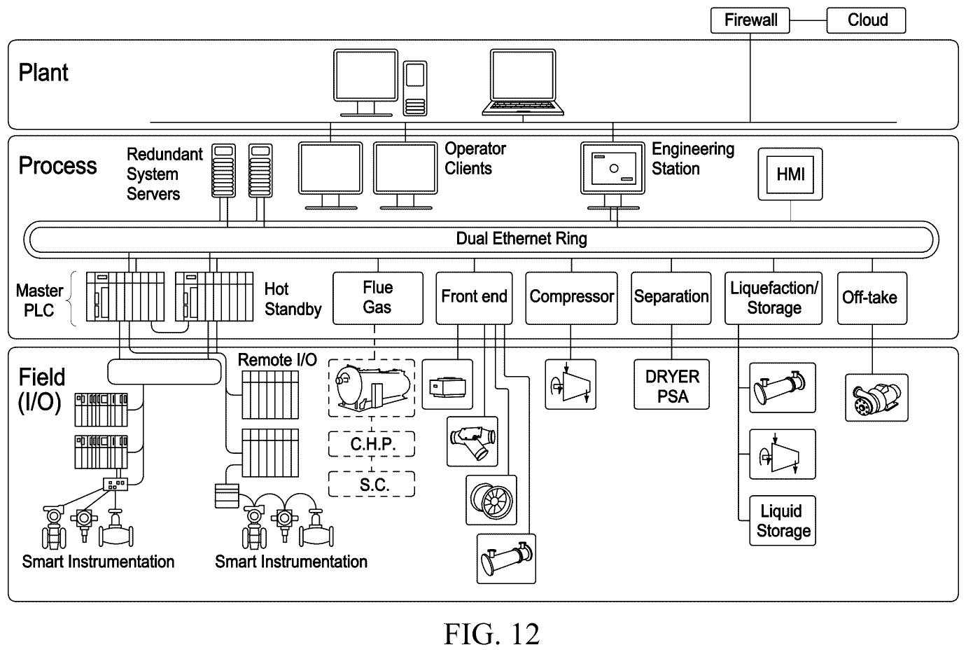

Accordingly, the boiler and system controls (for example FIG. 12) can achieve higher building thermal efficiency, while creating optimal conditions for flue gas supply to the systems and methods of the present disclosure.

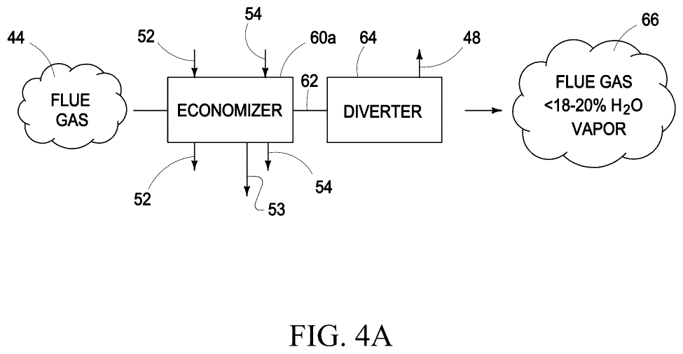

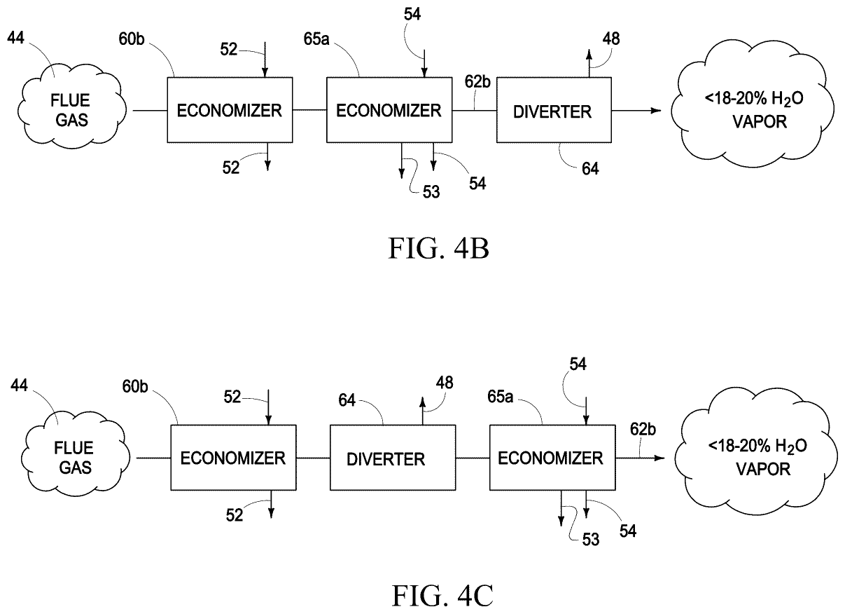

Referring next to FIGS. 4A-C, multiple portions of systems and methods are depicted for separating water from flue gas as well as cooling the flue gas. Referring first to FIGS. 4A-4C, three different configurations of systems and/or methods for cooling flue gas from a combustion boiler within a building are depicted. Referring first to FIG. 4A, flue gas 44 can proceed to a combination non-condensing and condensing economizer 60a. Flue gas 44 first proceeds to a non-condensing configuration in which boiler feed water 52 is provided through a conduit, set of conduits, and/or coils and flue gas is cooled and the boiler feed water heated. Accordingly, methods for cooling flue gas from a combustion boiler within a building are provided. Upon heating the boiler feed water, it can be provided to the boiler thus lowering the necessary energy required to heat the feed water to hot water and/or steam.

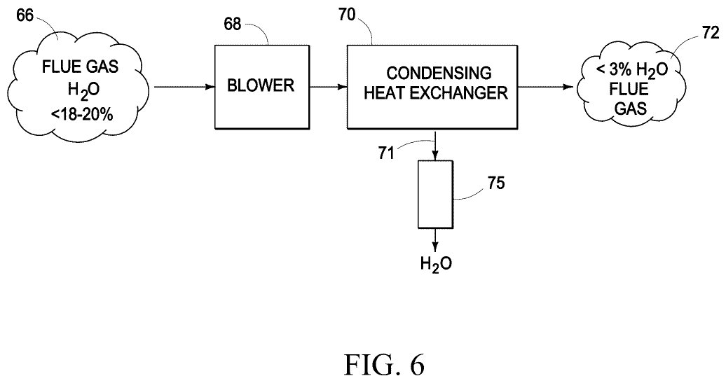

Additionally, the economizer can be configured for condensing. Accordingly, a conduit, set of conduits, or coils 54 can be configured to convey potable or industrial process water that is received from a utility for example. This water can have the temperature close to that of ground water as it is conveyed through typically underground pipes. Accordingly, the water has a substantially different temperature than the flue gas, even after being partially cooled in the non-condensing economizer. The providing of the flue gas to these conduits can remove water from the flue gas thus creating a water condensate effluent 53. This water proceeding through the conduits can be heated and provided to a water heating system 58 (FIG. 3C) as water heating system water intake 54, heated and received through outlet 56. Accordingly, the amount of energy needed to heat the water within water heating system 58 is less for at least the reason the water received for heating does not need to be heated from the lower temperature associated with typical utility water, rather it had been preheated. In accordance with an alternative configuration, and with reference to FIG. 4B, one set of coils 52 can be associated with one economizer 60b, and another set of coils 54 can be associated with another economizer 65a. In this configuration, economizer 60b can be a non-condensing economizer and economizer 65a can be configured as a condensing economizer. In accordance with another embodiment of the disclosure, a diverter 64 can be operably coupled to the economizers as shown in FIGS. 4A-4C. In accordance with example implementations, the cooled flue gas can be provided from diverter 64 using a blower. The systems and/or methods can control the amount of flue gas to be processed using the diverter. In accordance with example implementations, the current system in accordance with FIG. 4C is going to receive 450 Standard Cubic Feet per Minute (SCFM) to 500 SCFM of wet flue gas 44. This diverter can be controlled by the overall master system (FIG. 12) which can control the motor operated butterfly valve within the diverter. The master system can also collect gas temperature and flow data, and operate the blower as shown in FIG. 6.

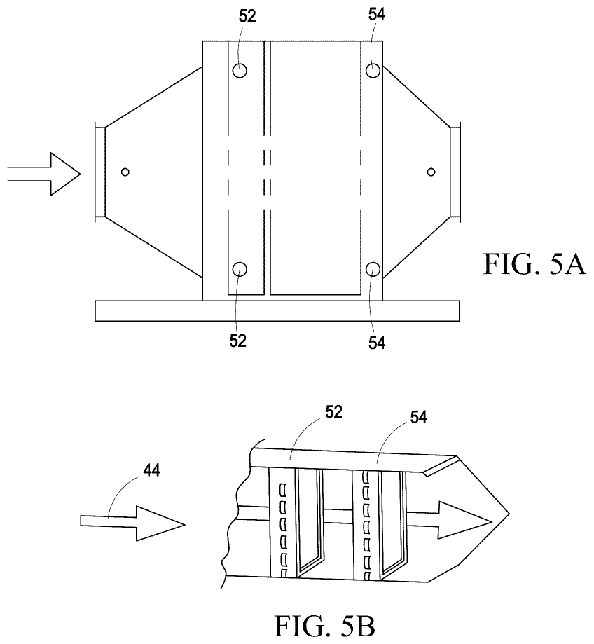

Accordingly, where an economizer is down process stream from a diverter, a blower may precede the economizer. In accordance with example implementations, the wet flue gas is at least about 8% carbon dioxide and/or at least about 3% free oxygen prior to entering the first economizer. The systems and/or methods of the present disclosure can utilize economizers configured as shown in FIGS. 5A and 5B for example, and the methods can include additional separation as well as liquefaction, storage, and transport.

It has been determined that flue gas from the boiler may have a water content of approximately 18%, and a temperature ranging up to 350° F. Prior to separation of CO₂, this water can be substantially removed from the flue gas. This involves dropping the flue gas temperature below dewpoint and allowing water to condense out as a liquid. As the water content of the flue gas lowers, so does the dewpoint, requiring yet additional cooling to continue removing the water. This cooling can result in flue gas condensates.

Flue gas condensates tend to be slightly acidic (at pH<=5) which is a condition that can damage some building plenums due to construction materials (such as carbon steel) which are not acid resistant. In these cases, gas must be removed from the plenum and condensed in external heat exchangers having acid resistant stainless steel components. Additionally, depending on condenser design, some amount of micro-liquid droplets may remain in the gas stream. These micro-liquid droplets can be referred to as acid aerosols which can be present at ppm levels. The present disclosure contemplates the removal of acid aerosols. These systems and/or methods include wet wall heat exchangers, impingers or mists eliminators with inert reticulated carbon or metal foam, and precipitators for example.

In accordance with the above, the non-condensing economizer can operate above dew point temperature, preventing any liquid condensate from forming. Without condensation, this economizer can be compatible with most plenum construction materials.

As described above, a condensing economizer can be provided downstream of the diverter (FIG. 4C) which extracts flue gas from the plenum and directs it on to the condensing economizer. Condensate from this condensing economizer can be chemically neutralized before proceeding to the building drain as shown by 75 in FIG. 6.

Referring next to FIG. 6, flue gas drying can continue with a blower 68 to increase pressure of flue gas from the diverter. This blower 68 can support flow through the heat exchanger/condenser 70 which can include a water outlet 71 operatively coupled to an acid neutralizer assembly 75. Heat exchanger 70 can be configured to cool the gas below dewpoint to condense out most water leaving less than about 3% water or as low as approximately 0.2% water.

Heat exchanger 70 can be a tube and shell configuration, cooled by an external water/glycol loop provided from a chiller and/or water from the building cooling tower for example. As shown, the water removed from the system at heat exchanger 70 can be slightly acidic, and it is anticipated that the water can be neutralized before proceeding to a Publicly Owned Treatment Works (POTW) or through a sewer system. Additionally, some water will remain in the process stream as small micro droplets, mist, or acidic aerosols which will be minimized or removed with special heat exchanger designs, mist eliminator, impingement devices, or possibly a precipitator. These components may produce additional condensate or effluent which can be treated before proceeding to a POTW.

After a preponderance of water has been removed, and acidic aerosols mitigated, the cooled flue gas 72 can continue on to a compressor to increase pressure of the flue gas to an optimum level of approximately 100 psig, or lower, as dictated by the PSA system specification. Since compression raises process gas dew point, the compressor may produce additional condensate or effluent.

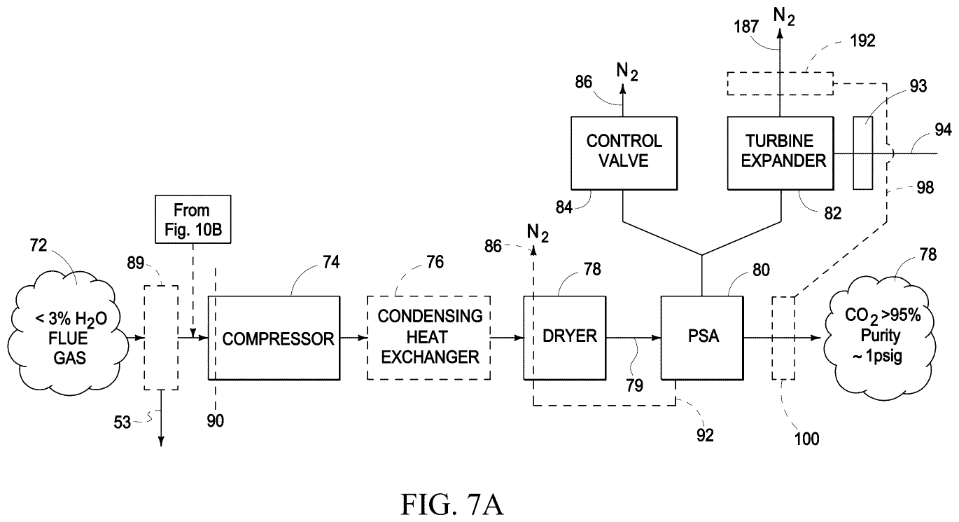

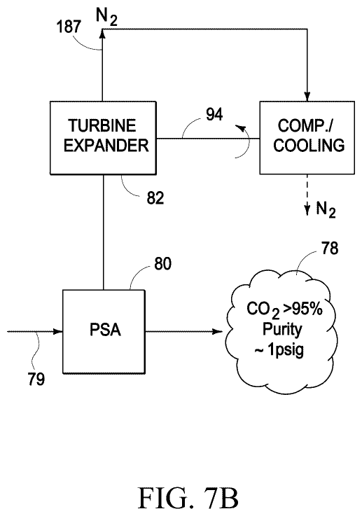

Referring next to FIG. 7A, compressor 74 can receive processed flue gas 72. Compressor 74 can be an “oil free” compressor to eliminate downstream product contamination, and the compressor can be configured with variable frequency drives (VFD's) to respond to variable gas flows. Compression can raise the temperature and dew point of the flue gas, so a second heat exchanger 76 can be utilized to lower the temperature of the flue gas to less than 40° C. At this stage, the gas can have less than about 0.2% water which can exist as a vapor, the gas can be less than 40° C. temperature, and can be about 100 psig in pressure.

Referring to FIG. 7A, the systems and/or methods for separating carbon dioxide from flue gas can include providing flue gas 72 having less than about 3% water; compressing the flue gas; and cooling compressor 74 with a heat transfer fluid 90 and providing the heat transfer fluid to/from a chiller and/or a cooling tower.

In accordance with another example implementation, mist eliminator subsystem 89 can be provided which can produce an effluent 53. During water removal from flue gas, liquid condensate as effluent at other points in the process or system can be produced. This effluent can be slightly acidic (approx. 5 pH) and can be neutralized before being provided to the building drain.

A very small amount of this slightly acidic condensate remains entrained in process gas as mist or acid aerosols. In order to remove these liquid micro-droplets, mist eliminator sub-system 89 can be added just prior to the compressor inlet. This subsystem can be an electrostatic unit, wet walled heat exchanger, or a passive impinger arrangement comprised of reticulated metal or carbon foam, wire mesh pad, or other material designed with a tortuous gas path causing mist particles to strike surface areas, nucleate and drain from the system by gravity. By reducing or eliminating acid aerosols, the mist eliminator solution can significantly prevent harmful corrosion in downstream components of the process gas stream. Accordingly, the mist eliminator can produce effluent 53 which can be neutralized and provided to a drain.

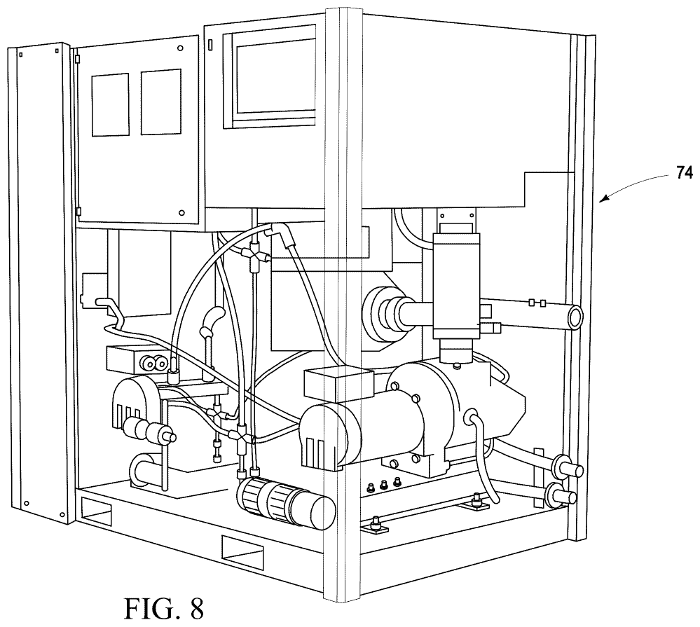

An example compressor is depicted in FIG. 8. The heat transfer fluid can be water for example, and the water of the chiller can be cooled within a cooling tower of the building before returning spent heat transfer fluid to the chiller. Accordingly, the systems and/or methods of the present disclosure can include additional separation, liquefaction, storage, and/or transport. This is just one example of the heat generating components of the system that can be cooled with chiller and/or cooling tower heat transfer fluid. Over 70% of the cooling requirement for the systems and/or methods of the present disclosure can come from heat generated in compressors and/or pumps, and from heat exchangers on the liquefaction skid. Each of these components can be provided with a water cooling circuit supplied from a local chiller or directly from the central chiller. The local chiller can be water cooled with a water loop coming from the central chiller or from cooling water from the building cooling tower. The central chiller can be designed to prioritize heat transfer in the following order: a) domestic hot water makeup; b) cooling tower; c) exchange with outside air, for example.

Referring again to FIG. 7A, after compression the flue gas can be provided to a dryer 78, such as a desiccant dryer. Dryer 78 can be operatively engaged with a nitrogen feed, such as a sweep feed, configured to regenerate spent desiccant. Typically, the dryer is a two-chamber cycling device, wherein one chamber is drying while the other chamber is re-generated for drying, and those cycles continue. The nitrogen can be provided to spent desiccant in one chamber while the other chamber is drying flue gas. Accordingly, systems and/or methods for separating carbon dioxide from flue gas generated from a combustion boiler within a building are provided that can include drying the flue gas using nitrogen recovered during separation of carbon dioxide recovered from the flue gas. This recovered nitrogen can be conveyed from the pressure swing adsorption assembly 80 via conduit 92 to dryer 78 and then exhausted through the stack 86. In accordance with example implementations, the dried flue gas can be provided for additional separation, liquefaction, storage, and/or transport.

From the dryer, the processed flue gas 79, containing less than 10 ppm water, can proceed to pressure swing adsorption (PSA) assembly 80. This pressure swing adsorption assembly can provide greater than 85% CO₂ recovery, at greater than 95% purity, at 1 psig, from ambient to about 100° C. Maximum CO₂ output flow at this point can be approximately 40 SCFM. The remainder of the flue gas, mostly nitrogen may continue under pressure, and/or be split with a portion returning to dryer 78.

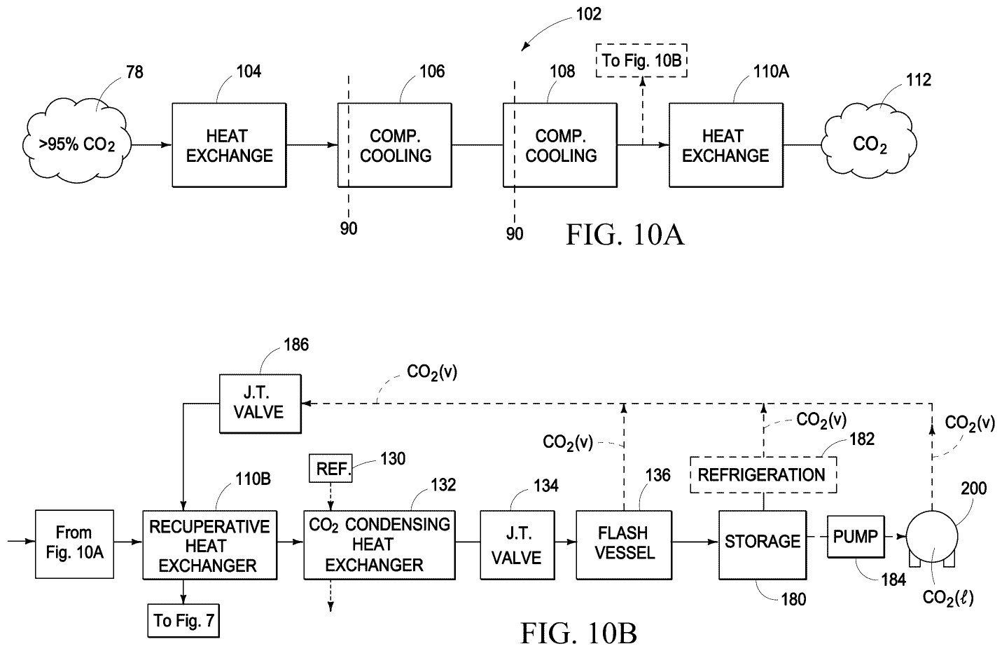

Another portion of the nitrogen can proceed to a turbine expander 82. At expander 82, thermal and/or mechanical energy can be provided. For example, the N₂ exhaust 187 from expander 82 can be of low temperature. This low temperature N₂ can be exposed to a heat exchanger 192 or provided to other portions of the system and utilized. As just one example, the low temperature N₂ can be provided to compressor/cooling stages 106 (FIG. 10A) as part of the liquefaction. Mechanical energy provided from shaft 94 can drive a generator 93 to provide electrical energy and/or to a compressor, such as the compressor/cooling stages 106 (FIG. 10A). The turbine expander can provide electrical energy and a cold output gas, at near ambient pressure. The electrical energy can be tied to the grid or returned to the system. The compressor can be operatively aligned to provide compression as desired. Additionally, a control valve 84 equipped with a silencer can be operationally aligned in parallel with expander 82 and/or generator and/or compressor 93. Accordingly, systems and methods of the present disclosure can include a PSA exhaust that is coupled to an expander having an exhaust that is coupled to liquefaction components and/or drying components of the system.

In accordance with another implementation, and as shown in FIG. 7B, the system can include a PSA 80 operatively engaged to receive a mixture of at least CO₂ and N₂. PSA 80 can be configured to separate at least some of the CO₂ from the N₂ and provide a CO₂ stream and an N₂ stream. As shown the N₂ stream can be provided to a turbine expander 82. Turbine expander 82 can be configured to drive a shaft 94 and provide low temperature N₂ 187. The shaft 94 can be operatively engaged with a compressor/cooling apparatus, such as compressor/cooling components 106 and/or 108 of FIG. 10A. The low temperature N₂ can be in fluid communication with the compressor/cooling apparatus. The compressor cooling apparatus can be configured to both compress and cool gases received to further process the gases. For example, CO₂ received can be further processed using compressor/cooling to provide CO₂ with higher purity as shown in FIG. 10A for example. The spent low temperature N₂, after use by the compressor/cooling apparatus, can be exhausted and/or used for the dryer as shown in FIG. 7A.

Accordingly, methods for separating carbon dioxide from flue gas can include removing at least some of the nitrogen from the flue gas to produce greater than about 95% carbon dioxide 78 using a pressure swing adsorption assembly 80. Nitrogen removed from the flue gas can be used to remove water from the flue gas before providing the flue gas to the pressure swing adsorption assembly, in dryer 78, for example. Alternatively, or additionally, at least some of the nitrogen removed from the flue gas can be provided to a gas expander/generator. Alternatively, or additionally one part of the nitrogen from the PSA can be provided to a control valve equipped with a silencer and providing another part to the expander/generator. In accordance with example implementations, the systems and/or methods of the present disclosure can include separating the nitrogen into parts and providing one part to the dryer and another part to the expander/generator. In one example implementation, the one part is about a third of the nitrogen from the pressure swing adsorption assembly.

In accordance with an example implementation, during the PSA process a small amount of rejected gas can be produced containing both CO₂ and nitrogen. Rather than purging this gas it can be recycled back through the compressor via recycle line 81 in order to enhance the overall recovery of CO₂.

Systems and/or methods are also provided for cooling carbon dioxide separated from flue gas generated from a combustion boiler within a building using the nitrogen exhaust of a PSA. The systems and/or methods can include separating nitrogen from flue gas using pressure swing adsorption assembly 80, and expanding the nitrogen through a turbine within the presence of a heat exchanger 92 to cool fluid within heat exchanger 92; and transferring that cooled fluid to another heat exchanger 100 operably aligned with the carbon dioxide product of the pressure swing adsorption assembly to cool the carbon dioxide product 78. The turbine can be part of a generator 93, for example, or may be provided to cool exchanger 92.

Typically, the nitrogen gas exiting the PSA can be at least 85 psig. with a flow exceeding 80% of the rated system flow. In accordance with example implementations, the nitrogen may be processed and saved as a marketable product. With regard to the electricity generation, grid compatible power conversion may be needed. The turbine generator will have a 500 Hz output which is not compatible with a 60 Hz grid. Therefore, it is envisioned that appropriate power conversion will be specified. This can be rectification followed by DC to AC multi phase inverter with proper safety features in case of a building power outage. After use in the turbine generator, and in the CO₂ heat exchanger, the nitrogen waste gas can proceed back to the exhaust stack or plenum.

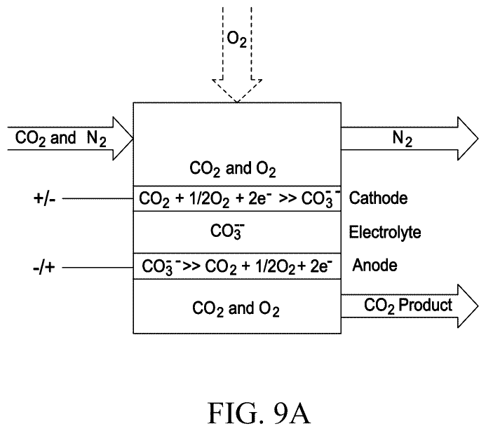

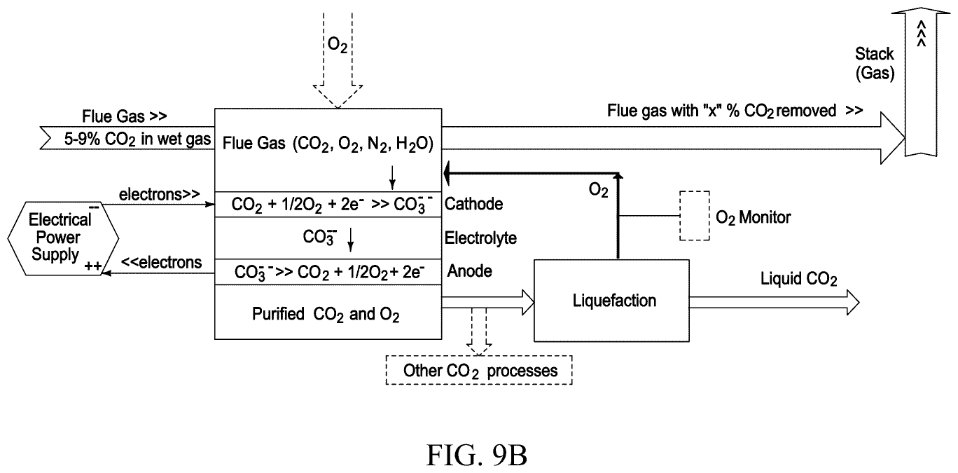

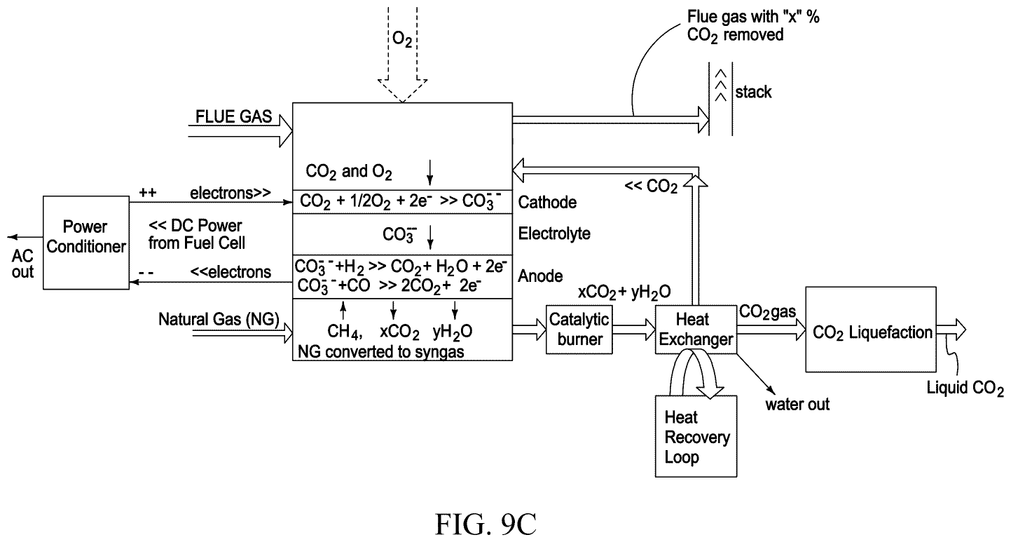

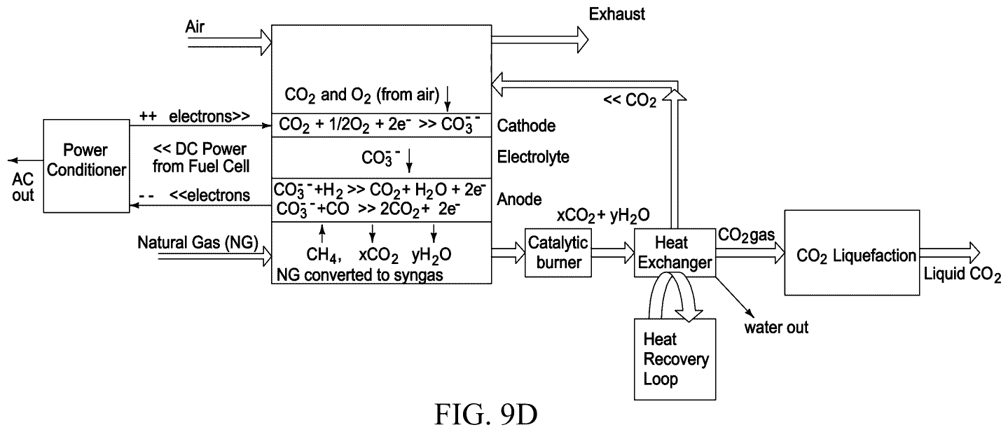

Referring to FIGS. 9A-9B, different embodiments of CO₂ separation systems and/or methods are depicted that can be used alone or in combination with some or all of the components of the systems and/or methods of FIG. 1.

For example, referring to FIG. 9A, an electrochemical cell is shown that includes a cathode configured to receive for reaction CO₂ and O₂. This CO₂ and O₂ may be received from the same or different streams. For example, the CO₂ can be received from a flue gas stream or may be received from an air stream. The flue gas stream may be CO₂ and N₂, it may also contain O₂, it may also contain H₂O in a range of concentrations. For example, the stream may be considered wet or dry, with a wet stream containing H₂O from the combustion process that generated the flue gas. The O₂ may be received as part of a flue gas stream, an air stream and/or as part of an O₂ stream.

Exiting the cathode side of the cell can be an N₂ stream. This N₂ stream may also contain CO₂ that did not react to form carbonate ion (CO₃²⁻). For example, it may contain CO₂, H₂O, and/or O₂. This N₂ stream will contain less CO₂ than the stream exposed to the cathode.

Upon exposure to the cathode and electrical coupling, the CO₂ is reacted to form the carbonate ion which is conveyed through the carbonate electrolyte to the anode where the electrical coupling returns the CO₃²⁻ to CO₂ and O₂ as a CO₂ product. As will be detailed below, this system can be implemented in a variety of ways; for example, as a carbonate ion pump (FIG. 9B), as flue gas carbonate fuel cell (FIG. 9C), and/or as fuel cell (FIG. 9D). In one or more of these implementations, CO₂ can be removed/separated/sequestered from one or more streams.

For example, and with reference to FIG. 9B, a portion of a carbon dioxide capture method and/or system is shown configured with a carbonate ion pump. As shown, the carbonate ion can be produced electrochemically on the surface of a cathode electrode by reacting carbon dioxide and oxygen from the air in the presence of electrons. The CO₂ can be obtained from flue gas in wet or dry form, and the O₂ can be part of the flue gas or provided from an O₂ source, from air for example. The flue gas can contain N₂ which will not react at the cathode and proceed to the gas stack along with any other components that did not react (e.g., H₂O, O₂, CO₂).

The electrochemical equation is: CO₂+½O₂+2e−→CO₃₋—. Multiple cells can be configured into stacks whereby CO₂ and O₂ are supplied through respective manifolds.

Once the carbonate ion is produced at the cathode, a solid or liquid electrolyte can be in ionic communication with the cathode providing a pathway for carbonate ions to move to the associated anode. This electrochemical activity is the basis for forming and transporting carbonate ions and for separating CO₂ from the original cathode gas mixture.

Upon reaching the anode, electrons can be removed from the carbonate ion(s) causing dissociation back to CO₂ and ½ O₂.

In accordance with another implementation of the present disclosure, CO₂ can be separated from flue gas using a membrane alone or in combination with other separation techniques. The membrane separation can utilize solvent absorption and/or polymeric based membranes with appropriate permeability and selectivity for CO₂. The polymeric membranes can include mixed polymeric membranes as well. Additional membranes can include carbon and/or inorganic membranes. CO₂ separation can be performed using membranes configured to perform Knudson diffusion, molecular sieving, solution-diffusion separation, surface diffusion and/or capillary condensation.

As shown in FIGS. 9B-9D, O₂ can be generated from the CO₂ product stream, for example during liquefaction. This O₂ can be provided to the cathode as part of the O₂ source. The amount of the O₂ being provided to the cathode can be monitored and/or adjusted as desired to operate the cell for optimal CO₂ separation.

In accordance with one embodiment of the disclosure and with reference to FIGS. 9C-9D, a carbonate fuel cell configuration can be provided with fuel, particularly hydrocarbon fuel sufficient to form syngas (H₂ and CO). The syngas can be formed from natural gas, and/or other hydrocarbon materials including, but not limited to coal. The cathode can be exposed to CO₂ and O₂ as described above to form the carbonate ion which can be exposed to the syngas at the anode to form CO₂ and H₂O as well as electrons to provide power output in the form of heat and electricity. This system can be part of a building design, replacing a power generator or boiler within a building, and/or as a stand alone system to provide heat and power.

The natural gas can be provided as part of the fuel cell and this natural gas can be tapped into from the intake to an existing building. Accordingly, while using natural gas which can be directly reformed to syngas at operational temperatures, heat and power can be generated electrochemically and this heat and power can be provided to the building thereby offsetting part or all of the building's thermal and power needs without natural gas combustion, thus, drastically reducing CO₂ emissions.

For example, the system can be paired with a common boiler system that is configured to combust natural gas. Accordingly, both the boiler and the system of the fuel cell can be configured to receive natural gas. Therefore, the system of FIG. 9C can provide heat and electrical power while the boiler provides thermal power in the form of steam. The system of FIG. 9C can be operationally aligned with CO₂ capture and purification systems as well.

Accordingly, the fuel cell can receive flue gas at the cathode and CO₂ is electrochemically purified and made available for separation and liquefaction. As shown, flue gas can be provided though a tortuous path to maximize CO₂ exposure to the cathode electrode surface area. This flue gas may be provided directly from the combustion boiler or it may be treated as described with reference to FIGS. 4-6 prior to being exposed to the cathode side of the fuel cell. Multiple cells can be configured in stacks with appropriate gas manifolds. This particular embodiment can offer increased performance in higher CO₂ concentrations thus allowing for less pretreatment of flue gas before CO₂ separation.

Upon reaching the anode, electrons can be removed from the carbonate ion(s) causing reformation of CO₂ and O₂. In accordance with FIGS. 9A-9D, the stream comprising CO₂ and O₂ can be provided to liquefaction as described, for example, herein with reference to FIG. 10. Non condensable oxygen can be separated and fed back to the Cathode side of the pump. As shown electrical energy can be provided to operate the pump. The pump can also utilize heat from the flue gas.

Accordingly, while using natural gas which is directly reformed to syngas at operational temperatures, heat and power can be generated electrochemically and this heat and power can be provided to the building thereby offsetting part or all of the building's thermal and power needs and without natural gas combustion.

Accordingly, syngas can be introduced at the anode and carbonate ions react exothermically to form more CO₂ and water vapor. At this stage a large substantial amount of the resulting gas can be purified CO₂. The concept further teaches removal of water vapor through condensation followed by CO₂ liquefaction.

Accordingly, systems for separating CO₂ from a combustion product are provided that can include a combustion product stream. This combustion product stream can be a wet stream or a dry stream that contains CO₂ and N₂, or for example CO₂, O₂, H₂O, and/or N₂. The system can include a carbonate ion pump or carbonate electrochemical cell operatively aligned with the combustion stream and configured to react the CO₂ and O₂ from the combustion product stream to form carbonate ion and react the carbonate ion to form a CO₂ product stream.

The carbonate electrochemical cell can include a cathode configured to receive electrons from a power supply and react those electrons with the CO₂ and O₂ of the combustion product stream to form the carbonate ion. This carbonate ion can be CO₃²⁻, for example and can be a component of a carbonate electrolyte. The cell can also include an anode configured to react the carbonate ion and form CO₂, O₂ and electrons. Accordingly, the system can include a cathode and anode about a carbonate electrolyte.

In accordance with additional embodiments, an O₂ source can be operatively coupled to the cathode of the carbonate electrochemical cell. In this configuration, the cathode can be configured to be exposed to CO₂ from the combustion stream and O₂ from the O₂ source. Further embodiments can utilize a syngas source operatively coupled to the anode to provide a carbonate fuel cell. In this configuration, the anode can be configured to receive the carbonate ion and the syngas and form the CO₂ product stream.

The system can include a catalytic burner operatively coupled to the CO₂ product stream as well as a heat exchanger operatively coupled to the catalytic burner and configured to remove O₂ from the CO₂ product stream. The heat exchanger can be operatively coupled to a heat recovery loop with an additional conduit configured to provide CO₂ to the cathode.

Methods for separating CO₂ from a combustion product stream can include receiving a combustion product stream comprising CO₂ and N₂; reacting the combustion product stream to form carbonate ion; and reacting the carbonate ion to form a CO₂ product stream. Electrons can be provided to form the carbonate ion, and electrons can be removed to form the CO₂ product stream.

Additionally, syngas can be provided to react with the carbonate ion to form the CO₂ product stream, and natural gas can be provided to form the syngas. Embodiments of this method can generate a net positive electrical potential upon forming the CO₂ product stream.

With reference to FIG. 9D, a system for separating CO₂ from air is provided. The system can include an air stream; the air stream can include at least CO₂ and N₂; and a carbonate fuel cell operatively aligned with the air stream and configured to react the CO₂ from the air stream and O₂ to form carbonate ion and react the carbonate ion to form a CO₂ product stream. An O₂ source can be operatively coupled to the cathode of the carbonate fuel cell, with the cathode being configured to react CO₂ from the combustion stream and/or O₂ from the source. As shown, this O₂ source can be from the CO₂ liquefaction process. A natural gas source can be operatively coupled to the anode of the carbonate fuel cell, with the anode configured to receive the carbonate ion and the natural gas and form the CO₂ product stream.

In some implementations, a portion of CO₂ can be returned to the cathode as required, with remaining CO₂ sent to liquefaction as described with reference to FIGS. 10-13B. In accordance with example implementations, the systems and/or methods of FIGS. 9A-9C may be used in combination with, or as an alternative to, PSA 80 of FIG. 7A. As shown in FIG. 7A, in accordance with alternative embodiments, additional CO₂ can be provided from a liquefaction and/or storage portion of the systems or methods shown, for example in FIG. 10B, to PSA 80 and/or one or more of cells of 9A-9C.

Referring next to FIG. 10A, in another series of components of the present disclosure, the >95% pure CO₂ 78 can be cooled and compressed in sequential steps as shown in heat exchangers 104, compressors 106 and 108, and heat exchanger 110A with compressors operatively engaged with cooling transfer fluid 90 to approach the phase change state for liquefaction. In accordance with example implementations, the >95% pure CO₂ can have a temperature coming out of the PSA of as high as 100° C. As described, a heat exchanger can be provided to lower the temperature of the gas to a sufficient temperature and then compress the gas to a higher pressure. In accordance with example implementations, heat removed from this CO₂ stream can be transferred through external water/glycol cooling loops back to a heat management system which will support preheating of makeup water as shown in FIG. 10A. It can also be provided to raise the temperature of nitrogen gas coming off of the PSA prior to expansion through the turbine. This can improve turbine efficiency by allowing full use of nitrogen flow before exceeding the COLD temperature output limit. This is just one of several examples of utilizing heat from system components at other portions of the system to derive a more efficient overall system. As shown in FIG. 10A, before heat exchange 110A, CO₂ can be transferred to and processed according to the system and/or method of FIG. 10B. The systems and/or methods of FIGS. 10A and/or 10B can be operated separately wherein just one of the systems and/or methods are operated.

Referring to FIG. 10B, a portion of a system for separating CO₂ from a flue gas source is shown. The system can include a flue gas source 11 that includes at least CO₂ and N₂. The flue gas source can be processed to remove water for example and provide a mixture of CO₂ and N₂ for separation component (see, e.g. FIGS. 7A and 9A-C) using a separation component operatively coupled to the flue gas source and configured to separate CO₂ from N₂ and form separated CO₂ (78). The liquefaction component (collectively 110B, 132, 134, and/or 136) of FIG. 10B can be operatively coupled to the separation component and include a recuperative heat exchanger 110B. Heat exchanger 110B can be configured to receive the separated CO₂ from the separation component and reduce the temperature of the separated CO₂ by exchanging the heat of the separated CO₂ with CO₂ vapor (CO₂ (v)) generated by the liquefaction component and/or a storage component (collectively 180, 182, and/or 184) operatively coupled to the liquefaction component, at for example heat exchanger 110B and configured to receive liquid CO₂ from the liquefaction component (e.g. flash vessel 136) and provide same as a heat exchange fluid for heat exchanger 110B. For example, the cooler CO₂ (v) cools the separated CO₂ when thermally exposed thereto within exchanger 110B. The CO₂ (v) is substantially lower in temperature than the separated CO₂. The CO₂ (v) is cooled through the expansive cooling from J.T valve 186 and can include non-condensable gases.

As shown, the storage component can include a CO₂ storage vessel 180 and/or CO₂ transport vehicle 200. One or both of the liquefaction component and/or the storage component can be operatively coupled with the recuperative heat exchanger 110B to provide at least a portion of the CO₂ gas generated during liquefaction and/or storage to the recuperative heat exchanger 110B for cooling the separated CO₂.

As shown, the liquefaction component can include flash vessel 136 operatively aligned between the liquefaction component (e.g., heat exchangers 110B or 132, and the storage component (e.g. storage vessel 180). A conduit can extend to convey the CO₂ (v) to recuperative heat exchanger 110B from flash vessel 136. The flash vessel is configured to be operatively aligned to provide separation of both CO₂ (v) and non-condensable gases.

The CO₂ condensing heat exchanger 132 can be operatively aligned between recuperative heat exchanger 110B and flash vessel 136. The CO₂ condensing heat exchanger can be configured to reduce the temperature of the CO₂ received from the recuperative heat exchanger and form CO₂ liquid.

A Joule Thomson valve 134 can be operatively aligned to receive the liquid CO₂ from the heat exchanger 132 and provide liquid CO₂ to flash vessel 136. Joule Thomson valve 134 is operatively aligned to receive CO₂ generated during liquefaction and provide liquid CO₂ to flash vessel 136. Valves 134 and/or 186 can be configured as throttling valves to provide cooling of the CO₂ as well as decreasing pressure.

The storage component can include a conduit configured to convey CO₂ vapor to recuperative heat exchanger 110B. The transport vehicle 200 can also be coupled to a conduit configured to convey CO₂ vapor to recuperative heat exchanger 110B. Transport vehicle 200 can be operatively engaged with storage component 180 via pressure differential apparatus (PUMP) 184 configured to provide pressurized CO₂ liquid to the transport vehicle.

As shown, one or more conduits can extend between portions of the liquefaction component and/or storage component, and recuperative heat exchanger 110B of the liquefaction component. These one or more conduits can be configured to convey CO₂ vapor to recuperative heat exchanger 110B. Joule Thomson valve 186 can be operatively aligned to receive CO₂ vapor from the one or more conduits and provide cooler CO₂ vapor to recuperative heat exchanger 110B.

Additionally, recuperative heat exchanger 110B can be operatively engaged via a conduit to provide heat exchanged CO₂ vapor from the recuperative heat exchanger to the separation component (e.g. FIGS. 7A and/or 9A-C).

Using the systems of the present disclosure, methods for separating CO₂ from a flue gas source can include receiving a flue gas source stream comprising CO₂ and N₂ (after drying for example). The CO₂ can be separated from the N₂ to form a primarily CO₂ stream (according to FIGS. 7A and/or 9A-C, for example). The CO₂ stream can be liquefied according to one of FIG. 10A or 10B to form both CO₂ liquid and CO₂ vapor. The methods can include using at least a portion of the CO₂ vapor to form the liquid CO₂ during the liquefying, for example, by heat exchanging the CO₂ vapor recovered from one or more of the flash vessel, the storage vessel, and/or the vehicle to reduce the temperature of the separated CO₂ gas entering heat exchanger 110B.

Accordingly, the methods can include exchanging heat between the CO₂ stream and the CO₂ vapor to cool the CO₂ stream and/or after exchanging heat between the CO₂ stream and the CO₂ vapor, providing the heat exchanged CO₂ vapor for separation and/or noncondensable removal. In accordance with at least one implementation, CO₂ (v) is provided to the PSA and the PSA removes at least some of the noncondensable gases as part of the separation process. Through returning (feedback) CO₂ vapor to the separator component (PSA), the CO₂ vapor is substantially retained thus improving overall CO₂ recovery by the system.

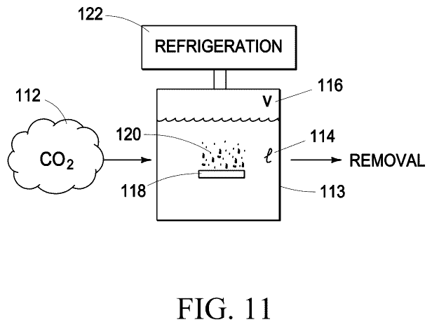

In accordance with FIG. 11, there is a stepwise cooling and compression sequence of the CO₂ gas, which drives towards a final state of 311 psig and 0° F., at which point phase change occurs and the CO₂ becomes a liquid.

Referring next to FIG. 11, a CO₂ liquefaction and storage system and/or method is shown wherein CO₂ gas 112 is sparged inside a vessel 113 such as an insulated vessel. Example insulated vessels can include but are not limited to vacuum jacketed liquid storage tanks. Within this vessel, gas 112 can be converted to a liquid 114. In accordance with example implementations, gas 112 can be provided to sparge assembly 118 where it is provided as sparged gas 120 which liquefies upon sparging into liquid 114.

Vapor 116 at the top of vessel 113 is managed by a refrigeration system 122 which cools vapor 116, which condenses back to liquid 114, which returns back into vessel 113. In accordance with example configurations, system 122 can be configured as a loop in fluid communication with vessel 113 wherein vapor CO₂ 116 enters system 122 and returns to vessel 113 as a liquid CO₂ 114. In at least one configuration, system 122 is configured as a low temperature condenser equipped with an evaporator.

In accordance with an additional embodiment, vessel 113 can be configured with a controlled venting subsystem to facilitate removal of non-condensable gases while minimizing loss of CO₂. Inlet gas to the CO₂ liquefaction system can be a high concentration of CO₂ preferably >95%. Remaining gases, such as nitrogen and oxygen, can be considered as non-condensable gases in the liquefaction process. In addition, a very small subset of impurity gases remain which are miscible with liquid CO₂. These impurities must be measured accurately in order to qualify the liquid CO₂ product in accordance with commercial standards, such as ISBT, the international beverage guideline. Both the controlled venting subsystem and the purity analytical system can account for non-condensable gases which can dissolve into the liquid.

Without preprocessing by a distillation tower, non-condensable gases in the continuous feed to liquefaction can build up in the storage system vapor space 116. Without removal, these non-condensable gases can continue to build pressure in the vapor space of the storage tank causing some of the gas to dissolve into the liquid, thus contaminating the liquid. In addition, excessive pressure in the tank can inhibit both the gas feed system and the refrigeration system which manages vapor and re-condenses CO₂ as liquid back into the tank. The venting system can be controlled to manage tank vapor space in conjunction with the refrigeration unit to release non-condensable gases, reduce pressure buildup, while minimizing loss of CO₂ vapor. Instrumentation (see for example, FIG. 11) at the tank can be configured to acquire and provide data regarding vapor pressure, dissolved gas, vapor composition, gas flow, etc. to the processor which can operate solenoid valves on vent lines to enact controlled release of tank vapor within strict parameters.

In the event of building power loss, the superior insulation of a vacuum jacketed tank, for example, may maintain liquid CO₂ for at least 30 days. In accordance with example implementations, the building itself may be able to tap into vessel 113 for a supply of CO₂ to extinguish fires; for example, fires related to electronic components that require CO₂ extinguishing methods.

With reference to FIGS. 1, 12, 13A, and 13B, in accordance with other example implementations, a CO₂ removal and/or delivery system is provided that can include off-take management using one or more vehicles provided in concert with CO₂ removal and/or delivery needs as provided by system control. For example, a removal and/or delivery truck 200 can be provided which transfers CO₂ directly from vessel 113 via a transfer pump 202 into a liquid CO₂ tank affixed to truck 200. The system can be configured to generate CO₂ pick up times based on numerous parameters, such as: vessel 113 capacity, system 10 CO₂ generation, legal date/time pickup windows; and/or CO₂ delivery needs. With respect to CO₂ delivery needs, it is contemplated that such high purity CO₂ can be delivered to a user directly without being warehoused or the need for additional purification. Just one example of direct delivery can be delivery to a wastewater treatment plant. In any case, however, offtake analytics can be provided to qualify the product with the ability to issue a Certificate of Analysis before transport.

Referring next to FIG. 12, plant, process and field level components of a control system are shown. In accordance with an example implementation, an example overall control system is provided that shows combustion emission and control, MASTER PLC controller, the diverter, the compression, dryer, separation, cooling and compression, refrigeration/storage, and the providing of food grade CO₂. These systems are also coupled to utility systems of electricity, natural gas, and water. These control systems exemplify a basic Network Architecture Diagram. The MASTER PLC controls the entire plant with Ethernet loop connections and with Internet IP protocol communications to the Local Packaged controllers, and through direct connection and control to the digital and analog I/O field instrumentation level. The HMI server gathers data from the MASTER PLC, manages plant real time displays, executes logging, data management applications, and communicates through the secure firewall to external users. Also implied is the Engineering Development workstation which maintains all operational software and updates which are periodically downloaded to the MASTER PLC.

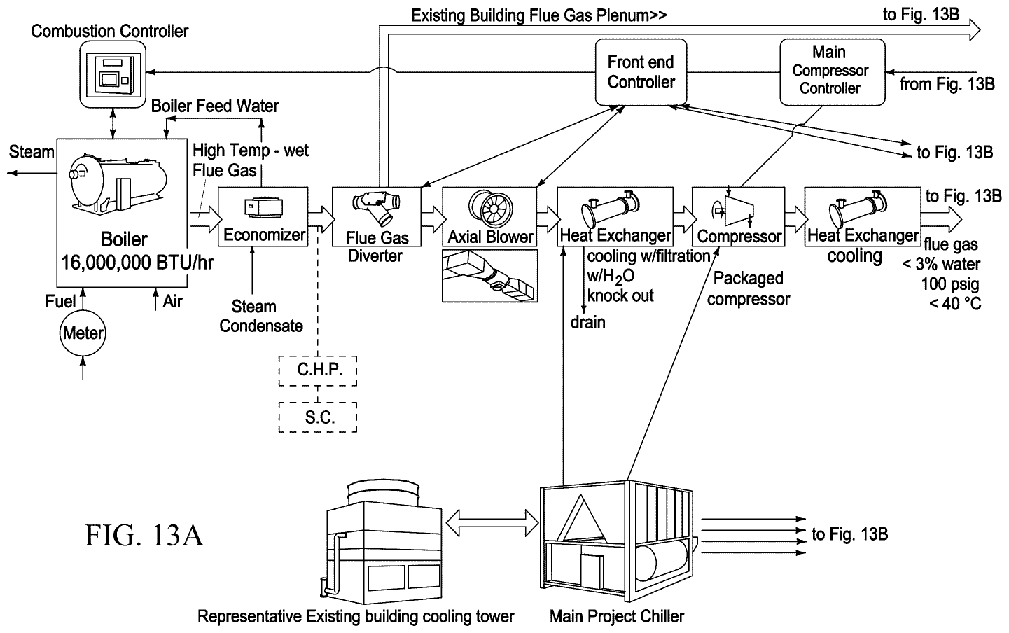

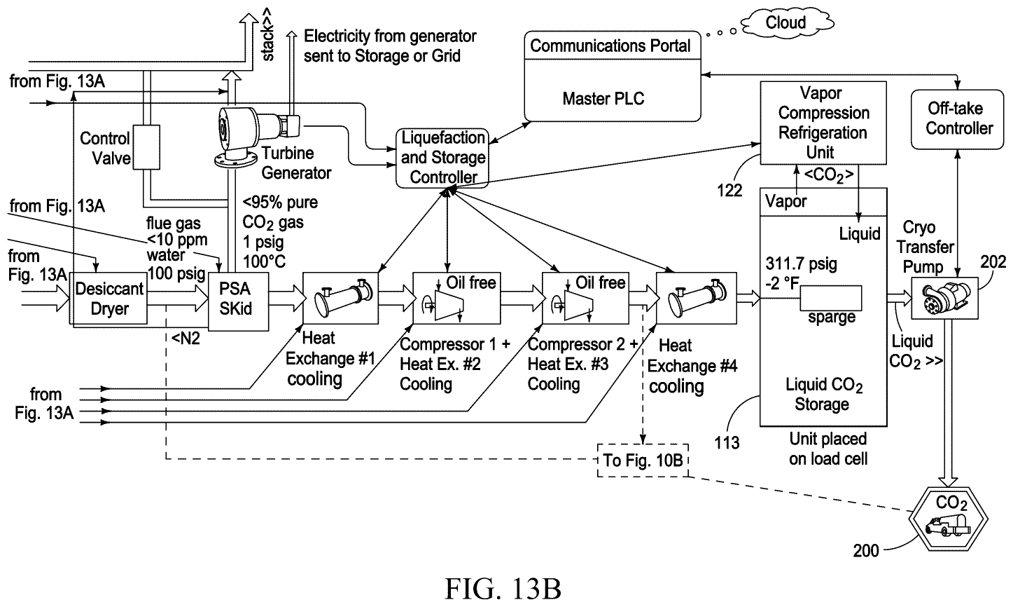

Referring to FIGS. 13A and 13B, an example implementation of the systems and/or methods is disclosed which details the sequence of the different components and processes described herein, as well as additional thermal management components that are associated with the building. As can be seen throughout the Figures and accompanying description, there are multiple places for heat to be transferred from different components of the disclosed system to existing building systems. For example, as shown, chillers can be in the building, as well as existing cooling towers. These active cooling components can be operably coupled with heat being removed from process components via individual cooling loops. In accordance with example implementations heat, sometimes referred to as waste heat, can be transferred to building systems which can use extra heat to operate more efficiently. Therefore, regarding waste heat from the disclosed system, design preference is to transfer waste heat, firstly to building steam and hot water makeup systems, secondly to the building cooling tower, and finally to an appropriate chiller with heat exchange to air.

As shown in FIGS. 12 and 13A-B, a thermal management system (see, e.g., MASTER PLC, controllers, etc.) can conserve use of fuel such as natural gas in the boiler by optimizing the combustion with the combustion controller, control water removal from the flue gas with the front end controller, perform additional separation with the dryer and PSA with the separation controller, liquefy and store CO₂ with the liquefaction/storage controller, and dictate off-take to a pickup and/or delivery truck with the off-take controller. These and additional controllers can work to control boiler feed water, potable and/or industrial water, chiller water, and/or cooling tower water, as well as nitrogen expansion cooling to reduce and/or eliminate heat loads in the system. Accordingly, flue gas can be cooled for water knockout, and heat generating electrical components such as compressors, blowers, pumps, and fans can be cooled as well.

Additionally, localized gas analytic instruments can be configured to provide localized CO₂ and O₂ concentration measurements in near real time. By locating gas sampling instruments/sensors directly at sampling points within subsystems like the PSA subsystem, small streams of sample gas can be pumped through sensor caps just inches away from the process gas to be measured. This innovation provides near instantaneous measurements at sub second sampling rates from multiple devices simultaneously. Each measurement device can be configured to prepare and format data for immediate transmission to the master controller using standard communication protocols. Individual sensor devices can be uniquely addressed by the master controller over a common hardwire connection (ethernet, RS232, RS485, etc.).

As indicated above, in order to meet commercial requirements for transporting and marketing liquid CO₂, off-take analytics can be provided that are integrated into the system in order to certify off-take weight of liquid CO₂ removed, and to qualify CO₂ product purity within required commercial standards. This off-take analytical system can be configured to issue a Certificate of Analysis for the product CO₂ at the time it is transferred out of the building, or from an intermediate storage and processing facility. In addition, the off-take analytical system can be configured to document all information to officially account for all off-take transactions.

In accordance with an example implementation, a set of electronic load cells can be placed underneath each storage tank to accurately measure weight of the tank and its contents. The system will make a difference calculation to certify weight of liquid CO₂ removed.

In accordance with another implementation, the analytical system can be configured to measure product impurities within exacting standards. Just before product transfer the analytical system will automatically take a small liquid CO₂ sample from the storage tank, vaporize it, and then flow the sample gas to a state of the art FTIR spectrum analyzer or to a field grade gas chromatograph system. The FTIR spectrum analyzer will be equipped with procedures and chemical spectral libraries sufficient to identify and measure all “impurities” shown on the customers contractual purity specification for liquid CO₂. Such specifications usually stipulate the ISBT beverage guideline along with one or more additional compounds of importance to the customer. At least one advantage of the FTIR analytical system is that it will be configured to operate automatically, not requiring manual assistance, while providing several times more measurement fidelity than required by the ISBT guideline. It is generally understood that FTIR systems cannot measure chemical compounds which do not exhibit a molecular dipole. This does not apply to impurities of interest, since they all exhibit molecular dipoles, with several degrees of motion (observable frequencies).

Additionally, in a separate embodiment the FTIR system can also be connected to the “front end” to accurately measure impurities of flue gas from the boiler system.

In accordance with example implementations, the systems and/or methods of the present disclosure can include an energy storage system that can be configured to include a power conversion component and/or a battery or battery bank component. As one example, energy can be generated via turbine expansion of the nitrogen and this energy can be converted and stored within the building. The energy may be converted and provided directly to system components, for example compressors, and/or provided to the system components after storage, thus lowering building energy demand. Additionally, the energy may be provided to the power grid associated with the building itself.

In accordance with example implementations, using the MASTER PLC, energy generated with the system can be utilized during “peak demand” times (when, for example electricity rates are higher) and/or when the building is utilizing a “peak” amount of power. During these times, the MASTER PLC is monitoring building demand and then modify the system parameters to efficiently use energy storage and/or change carbon dioxide separation, liquefaction, storage, and/or transport to lower energy consumption during “peak demand” thus providing energy cost savings.

Example implementations of the systems and/or methods of the present disclosure can provide not only a carbon capture system but also an improvement in overall building energy efficiency (both thermal and electrical) while lessening CO₂ emissions. Example implementations can include lowering carbon fuel consumption through optimizing boiler combustion, providing warmer boiler feed water thus requiring less energy to heat the boiler feed water, warming potable or process water thus requiring less energy to the heat the potable or process water, generating electrical energy and using same to power system components, and/or using building cooling towers to reduce building thermal load, etc., which individually and/or collectively can be part of systems that dramatically improve building efficiency.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

1. A system for separating CO₂ from a flue gas source, the system comprising:
a flue gas source; the flue gas source comprising at least CO₂ and N₂;
a separation component operatively coupled to the flue gas source and configured to separate CO₂ from N₂ and form separated CO₂;
a liquefaction component operatively coupled to the separation component and comprising a recuperative heat exchanger configured to receive the separated CO₂ from the separation component and reduce the temperature of the separated CO₂ by exchanging the heat of the separated CO₂ with CO₂ vapor generated by the liquefaction component and/or a storage component operatively coupled to the liquefaction component and configured to receive liquid CO₂ from the liquefaction component; and
the storage component comprising a CO₂ storage vessel and/or CO₂ transport vehicle; wherein one or both of the liquefaction component and/or the storage component are operatively coupled with the recuperative heat exchanger to provide at least a portion of the CO₂ vapor generated during liquefaction and/or storage to the recuperative heat exchanger for cooling the separated CO₂.

2. The system of claim 1 wherein the flue gas source comprises one or more of a combustion boiler, a combined heat and power generator, and/or a sorbent chiller.

3. The system of claim 1 wherein the separation component comprises one or more of a pressure swing adsorbent assembly, a membrane assembly, and/or an electrochemical cell.

4. The system of claim 1 wherein the liquefaction component further comprises a flash vessel operatively aligned between the liquefaction component and the storage component, the flash vessel comprising a conduit configured to convey the CO₂ vapor to the recuperative heat exchanger.

5. The system of claim 4 further comprising a CO₂ condensing heat exchanger operatively aligned between the recuperative heat exchanger and the flash vessel, the CO₂ condensing heat exchanger configured to reduce the temperature of the CO₂ gas received from the recuperative heat exchanger and form CO₂ liquid.

6. The system of claim 5 further comprising a Joule Thomson valve operatively aligned to receive the CO₂ liquid from the CO₂ condensing heat exchanger and provide CO₂ liquid to the flash vessel.

7. The system of claim 4 further comprising a Joule Thomson valve operatively aligned to receive CO₂ generated during liquefaction and provide liquid CO₂ to the flash vessel.

8. The system of claim 1 wherein the storage component further comprises a conduit configured to convey the CO₂ vapor to the recuperative heat exchanger.

9. The system of claim 1 wherein the transport vehicle further comprises a conduit configured to convey the CO₂ vapor to the recuperative heat exchanger.

10. The system of claim 9 wherein the transport vehicle is operatively engaged with the storage component via pressure differential apparatus configured to provide pressurized CO₂ liquid to the transport vehicle.

11. The system of claim 1 further comprising one or more conduits extending between portions of the liquefaction component and/or storage component and the recuperative heat exchanger of the liquefaction component, the one or more conduits configured to convey CO₂ vapor to the recuperative heat exchanger.

12. The system of claim 11 further comprising a Joule Thomson valve operatively aligned to receive CO₂ vapor from the one or conduits and provide cooler CO₂ vapor to the recuperative heat exchanger.

13. The system of claim 12 further comprising operatively engaging the recuperative heat exchanger via a conduit to provide heat exchanged CO₂ vapor from the recuperative heat exchanger to the separation component.

14. The system of claim 13 wherein the separation component comprises one or more of a pressure swing adsorbent assembly, a membrane assembly, and/or an electrochemical cell.

15. A method for separating CO₂ from a flue gas source, the method comprising:
receiving a flue gas source stream comprising CO₂ and N₂;
separating the CO₂ from the N₂ to form a primarily CO₂ stream;
liquefying the CO₂ stream to form both CO₂ liquid and CO₂ vapor; and
using at least a portion of the CO₂ vapor to form the CO₂ liquid during the liquefying.

16. The method of claim 15 wherein the liquefying comprises exchanging heat between the CO₂ stream and the CO₂ vapor to cool the CO₂ stream.

17. The method of claim 16 further comprising, after exchanging heat between the CO₂ stream and the CO₂ vapor, providing the CO₂ vapor for the separating.

18. The method of claim 15 wherein the CO₂ vapor comprises noncondensable gases, the method further comprising providing the CO₂ vapor to a PSA assembly to remove at least some of the noncondensable gases.

19. The method of claim 15 further comprising storing and/or transporting the liquid CO₂.

20. The method of claim 19 further comprising generating additional CO₂ vapor during the storing and/or transporting, and providing that additional CO₂ vapor for the forming of the CO₂ liquid.

21. A system for separating CO₂ from N₂, the system comprising:
a pressure swing adsorption component operably configured to receive a mixture of CO₂ and N₂, and provide a stream comprising CO₂ and a stream comprising N₂;
a turbine expander operably engaged with the pressure swing adsorption component to receive the stream of N₂, the turbine expander configured to drive a shaft upon expansion of the N₂ and provide a stream of low temperature N₂; and
a compressor/cooling apparatus operatively engaged with both the stream of low temperature N₂ and the shaft, the compressor/cooling apparatus configured to utilize mechanical energy of the shaft and the low temperature N₂ to both compress and cool a gas.

22. The system of claim 21 further comprising a source of CO₂ and N₂.

23. The system of claim 22 wherein the source is a combustion boiler.

24. The system of claim 23 further comprising compressors and/or dryers configured to remove H₂O from flue gas of the combustion boiler.

25. The system of claim 24 wherein one or more of the compressors and/or dryers are operatively coupled with the shaft of the turbine expander and/or the low temperature N₂ stream.

26. The system of claim 21 wherein the compressor/cooling apparatus is a component of a liquefaction system.

27. The system of claim 26 wherein the liquefaction system is configured to one or both of purify and/or liquefy CO₂ received from the pressure swing adsorption assembly.
